(19) United States
(12) Patent Application Publication
(10) Pub. No.: US 2018/0364817 A1
(43) Pub. Date: Dec. 20, 2018

(54) OPERATING DEVICE

(71) Applicant: DENSO CORPORATION, Kariya-city, Aichi-pref. (JP)

(72) Inventor: Yukihide OTA, Kariya-city (JP)

(21) Appl. No.: 16/060,499

(22) PCT Filed: Sep. 26, 2016
(86) PCT No.: PCT/JP2016/078141

§ 371 Date: Jun. 8, 2018

(30) Foreign Application Priority Data
Dec. 14, 2015 (JP) 2015-243351
Dec. 14, 2015 (JP) 2015-243352
Aug. 3, 2016 (JP) 2016-153198
Aug. 3, 2016 (JP) 2016-153199

(51) Int. Cl. G06F 3/0362; G06F 3/01; G05G 1/10; B60K 37/06

(52) U.S. Cl. CPC G06F 3/0362; B60K 37/06; G05G 1/10; G06F 3/016

(57) ABSTRACT

A scroll wheel in a ring shape partially protrudes from an opening portion of an operation surface. A rotational shaft is located on one axial side of the scroll wheel and is rotational together with the scroll wheel. A fixed shaft is inserted inside the scroll wheel on another axial side and rotationally supports the scroll wheel while being non-rotational. A corrugated portion is formed on an inner peripheral surface of the scroll wheel and is continuous in a circumferential direction. A hole portion is recessed at a position, which corresponds to the corrugated portion in an axial direction, beyond a center position of the fixed shaft. An elastic member is inserted in the hole portion. A click pin is slidable along an inner peripheral surface of the hole portion and has a tip portion urged onto the corrugated portion with the elastic member.

### CROSS REFERENCE TO RELATED APPLICATION

This application is based on Japanese Patent Applications No. 2015-243351 filed on Dec. 14, 2015, No. 2015-243352 filed on Dec. 14, 2015, No. 2016-153198 filed on Aug. 3, 2016, and No. 2016-153199 filed on Aug. 3, 2016, the disclosure of which is incorporated herein by reference.

### TECHNICAL FIELD

The present disclosure relates to an operating device to perform an input on a predetermined device in response to rotation of a scroll wheel.

### BACKGROUND ART

As a conventional operating device, for example, an operating device disclosed in Patent Literature 1 has been known. The operating device (dial operating device of a camera) of Patent Literature 1 includes a flat umbrella-shaped dial member, which is located on an upper side of a plate-shaped exterior member and is rotationally operated, and a click mechanism which gives a click feeling to an operator when the dial member is rotated.

A shaft portion extending toward an umbrella-shaped opening side is formed at a rotation center of the dial member. Further, a corrugated friction slide portion continuous in a circumferential direction is formed on an inner peripheral surface of the dial member. On the other hand, the plate-shaped exterior member is provided with a flat columnar protrusion portion protruding along an internal space of the dial member. A shaft hole is provided at the center of the protrusion portion, and the shaft portion of the dial member is inserted through the shaft hole so that the dial member is rotationally supported. Further, a hole portion recessed into the shaft portion side of the dial member is provided at a predetermined position on the circumferential surface of the protrusion portion. A ball functioning as a slide member is located in the vicinity of the opening portion of the hole portion, and a coil spring for urging the ball against the corrugated friction slide portion is accommodated in the hole portion. The corrugated friction slide portion, the hole portion, the ball, and the coil spring form the click mechanism.

In the operating device of Patent Literature 1, when the dial member is rotated, the ball moves in a radial direction of the dial member along the corrugated friction slide portion to give the click feeling at the time of performing the rotating operation.

However, in the operating device of Patent Literature 1, the shaft portion of the dial member is inserted through the axial hole of the protrusion portion. Therefore, a depth dimension of the hole portion for the click mechanism is restricted by the shaft portion. Therefore, the dimensions of the slide member (ball) provided in the hole portion and the dimensions of the coil spring in the dial member radial direction are naturally restricted.

Therefore, the slide member has been already brought into a state where it can easily fall off from the hole portion at a stage where the slide member is set in the hole portion. Consequently, a concern arises about the assembling property of the dial member to the protrusion portion. In addition, the restriction of the dimensions of the coil spring makes it difficult to generate an excellent urging force against the slide member. Consequently, a favorable click feeling may be hardly produced.

As another conventional operating device, for example, an operating device disclosed in Patent Literature 2 has been known. The operating device (compound operating type input device) of Patent Literature 2 includes a scroll wheel (rotary operating body), which partly protrudes from an upper surface of a casing and is rotationally operated by an operator, and a rotation detection mechanism which detects a rotational state (rotation direction, rotation amount, or the like) of the scroll wheel.

The scroll wheel is rotationally supported by a support shaft provided inside the casing. A first gear is provided on one end side of the support shaft. Further, the rotation detection mechanism includes a rotational plate (code plate), which is formed in a disk shape, provided on the rotational shaft, and formed with multiple protruding teeth located on an outer circumferential portion in a circumferential direction, and a detection unit which detects the movement of the protruding teeth of the rotational plate.

The rotational shaft of the rotational plate is located in parallel to the support shaft of the scroll wheel and on a bottom surface side of the casing, and a second gear, which meshes with a first gear of the support shaft, is located on one end side of the rotational shaft. Therefore, the rotation detection mechanism is located axially adjacent to the scroll wheel in the casing.

When the scroll wheel is rotationally operated, a rotational force is transmitted to the support shaft, the first gear, the second gear, the rotational shaft, and the rotational plate in the stated order, and the movement of the protruding teeth of the rotational plate is detected with the detection unit, thereby to grasp the direction and an amount of rotation of the scroll wheel.

In the rotational plate of the rotation detection mechanism, a width of the protruding teeth, an inter-tooth pitch and the like are appropriately set, which enables the detection unit to accurately grasp the direction and the amount of rotation, and thus a diameter of the rotational plate is preferably set as large as possible. Therefore, when the diameter of the rotational plate is set large, a gap (space) between an upper surface of the casing and the rotational plate is reduced.

In this case, in the operating device, a display device may be provided on the upper surface of the casing so as to be adjacent to the scroll wheel. The display device displays, for example, set values of control items input and operated by using the scroll wheel.

In the operating device of Patent Literature 2, the gap between the upper surface of the casing and the rotational plate is reduced. Therefore, the configuration hardly provides the display device described above.

### PRIOR TECHNICAL LITERATURE

### Patent Literature

Patent Literature 1: JP-A-7-28151

Patent Literature 2: JP-A-2008-98044

### SUMMARY OF INVENTION

It is an object of the present disclosure to provide an operating device which is provided with a click mechanism in a scroll wheel, which is excellent in assembling property of the click mechanism, and which enables to give a favorable click feeling. It is another object of the present disclosure to provide an operating device enabling to easily set a display device at a position adjacent to a scroll wheel without being influenced by a rotation detection mechanism.

According to one aspect of the present disclosure, an operating device comprises a scroll wheel rotationally operational by an operator for input on a predetermined device. The scroll wheel is in a ring shape, partially protrudes on an operator side from an opening portion in an operation surface of a casing, and has an axial direction in a direction along the operation surface within the casing. The operating device further comprises a rotational shaft located on one axial side of the scroll wheel and rotational together with the scroll wheel. The operating device further comprises a fixed shaft inserted in the ring shape on an other axial side of the scroll wheel and rotationally supports the scroll wheel while being non-rotational. The operating device further comprises a corrugated portion formed on an inner peripheral surface of the scroll wheel and in a corrugated shape continuous in a circumferential direction. The operating device further comprises a hole portion recessed at a predetermined outer peripheral surface position, which corresponds to the corrugated portion in the axial direction of the fixed shaft, beyond a center position of the fixed shaft. The operating device further comprises an elastic member inserted in the hole portion. The operating device further comprises a click pin slidable along an inner peripheral surface of the hole portion and has a tip portion urged onto the corrugated portion with the elastic member.

According to an other aspect of the present disclosure, an operating device comprises a scroll wheel partially protruding on an operator side from an opening portion in an operation surface of a casing. The scroll wheel is axially supported in the casing in a direction along the operation surface and is rotationally operational by an operator for input. The operating device further comprises a rotational plate rotational on a rotational operation of the scroll wheel. The operating device further comprises a detection unit located on a radially outside of the rotational plate and to detect a rotational state of the rotational plate so as to detect a rotational state of the scroll wheel. The operating device further comprises a display device located on one side of the operation surface, located adjacent to the scroll wheel in an axial direction, and to display an input state corresponding to the rotational operation of the scroll wheel. The operating device further comprises a first gear fixed on an opposite side of the scroll wheel from the display device in the axial direction and rotational together with the scroll wheel. The operating device further comprises a second gear located on a side of the first gear away from the operation surface, meshes with the first gear, and rotational at a reduced speed relative to the first gear. The operating device further comprises a third gear located on a side of the second gear away from the operation surface, meshes with the second gear, and rotational at an increased speed relative to the first gear. The operating device further comprises a gear shaft rotational with the third gear. The rotational plate is fixed to the gear shaft and is located on a display device side in the axial direction of the scroll wheel.

### BRIEF DESCRIPTION OF THE DRAWINGS

The above and other objects, features and advantages of the present disclosure will become more apparent from the following detailed description made with reference to the accompanying drawings. In the drawings:

The objects and other objects, features, and advantages of the present disclosure will be more clarified on the basis of the following detailed descriptions with reference to the accompanying drawings. In the drawings,

FIG. 1 is a cross-sectional view showing an overall configuration of an operating device according to a first embodiment;

FIG. 2 is a view as seen from a direction II in FIG. 1;

FIG. 3 is an exploded view showing a rotational shaft and a fixed shaft in a scroll wheel according to the first embodiment;

FIG. 4 is a cross-sectional view taken along a line III-III in FIG. 1;

FIG. 5 is a cross-sectional view taken along a line IV-IV in FIG. 1;

FIG. 6 is a cross-sectional view showing an overall configuration of an operating device according to a second embodiment;

FIG. 7 is an exploded view showing a rotational shaft and a fixed shaft in a scroll wheel according to the second embodiment;

FIG. 8 is a cross-sectional view showing an overall configuration of an operating device according to a third embodiment;

FIG. 9 is a view taken along a line IX in FIG. 8;

FIG. 10 is a cross-sectional view showing an overall configuration of an operating device according to a fourth embodiment;

FIG. 11 is a cross-sectional view showing a sliding surface of a scroll wheel taken along a line XI in FIG. 10;

FIG. 12 is a view as seen from a direction XII in FIG. 10; and

FIG. 13 is a cross-sectional view taken along a line XIII-XIII in FIG. 12.

### DESCRIPTION OF EMBODIMENTS

Hereinafter, multiple aspects for implementing the present disclosure will be described with reference to the drawings. In each aspect, the same reference numerals are assigned to portions corresponding to contents described in a preceding aspect, and repetitive description may be omitted. When only a portion of a configuration in each aspect is described, other aspects described previously can be applied to other portions of the configuration. Not only portions which are specifically clarified so as to be combined in each embodiment are capable of being combined, but also embodiments are capable of being partially combined with each other even though combination is not clarified as long as no adverse effect is particularly generated with respect to the combination.

### First Embodiment

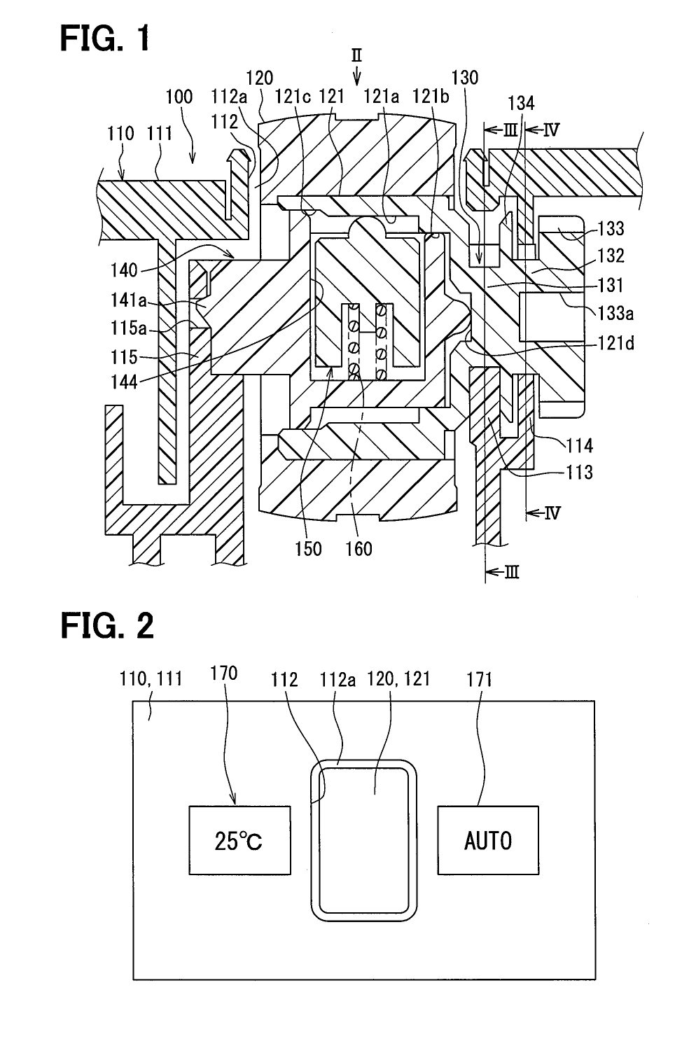

An operating device 100 according to a first embodiment will be described with reference to FIGS. 1 to 5. The operating device 100 is, for example, a device for changing (inputting) a set value of a predetermined control item in a vehicle air conditioning apparatus (predetermined equipment) and is provided in a center console of the vehicle. In this case, the operating device 100 changes, for example, a set temperature of an air conditioning wind as a predetermined control item. The operating device 100 includes a casing 110, a scroll wheel 120, a rotational shaft 130, a fixed shaft 140, a click pin 150, a spring 160, a display device 170, and the like. The respective components except for the spring 160 (steel material) and the display device 170 are made of, for example, a resin material.

The casing 110 is a box-shaped member that accommodates the respective components forming the operating device 100 inside. The casing 110 has an operation surface 111, an opening portion 112, support walls 113 to 115, and the like.

The operation surface 111 is a surface of the casing 110 on an operator (hereinafter, referred to as occupant) side and forms an operating panel for air conditioning. Basically, for example, a surface of the operation surface 111 is painted with a light-shielding paint and functions as a light shielding portion. However, a region of the operation surface 111 corresponding to the display device 170 is a portion not painted with the light shielding paint and functions as a light transmission portion.

The opening portion 112 defines a hole for allowing a part of the scroll wheel 120 to protrude toward the occupant. A gap 112a is formed between the opening portion 112 and the scroll wheel 120 around the opening portion 112.

The support wall 113 is a member that supports the rotational shaft 130 (first shaft portion 131) and is provided on one axial side of the scroll wheel 120 in the casing 110. The support wall 113 forms a wall surface in a direction intersecting with the operation surface 111. As shown in FIG. 4, the support wall 113 is formed in a U shape. The support wall 113 has a semicircular receiving portion 113a that receives the rotational shaft 130 and an opening portion 113b that opens from the receiving portion 113a toward the operation surface 111. The rotational shaft 130 is inserted into the receiving portion 113a from the opening portion 113b side, and the support wall 113 rotationally supports the rotational shaft 130 with the receiving portion 113a.

The support wall 114 is a member that supports the rotational shaft 130 (second shaft portion 132) and forms a wall surface that is parallel to the support wall 113 so as to be adjacent and opposite of the support wall 113 from the scroll wheel 120 in the casing 110. As shown in FIG. 5, the support wall 114 is formed in a C shape. The support wall 114 includes a C-shaped receiving portion 114a that receives the rotational shaft 130 and an opening portion 114b that opens from the receiving portion 114a toward the operation surface 111 side.

A thickness of the support wall 114 is set to such a thickness that the opening portion 114b can be elastically deformed in the radial direction (right and left direction in FIG. 5). The rotational shaft 130 is inserted into the receiving portion 114a from the opening portion 114b side. When the rotational shaft 130 is inserted into the receiving portion 114a, the opening portion 114b is deflected to spread outward in the radial direction, and after the rotational shaft 130 has been inserted into the receiving portion 114a, the opening portion 114b returns inward in the radial direction. The support wall 114 rotationally supports the rotational shaft 130 and regulates the position of the rotational shaft 130 in the radial direction.

The support wall 115 is a member that supports the fixed shaft 140 (fixed portion 141) and is provided on the other axial side of the scroll wheel 120 in the casing 110. The support wall 115 forms a wall surface in a direction intersecting with the operation surface 111. The support wall 115 is provided with a locking hole 115a for locking the locking claw 141a of the fixed shaft 140. The support wall 115 is provided with multiple wall portions that is in surface contact with the fixed shaft 140 so that the fixed shaft 140 is not rotational. The support wall 115 is a wall that fixes (or restrict rotation of) the fixed shaft 140.

The scroll wheel 120 is a member that is rotationally operated by the occupant to cause the air conditioning apparatus to change (input) the set temperature of the air conditioning wind. The scroll wheel 120 is formed in a ring shape. The scroll wheel 120 partially protrudes from the opening portion 112 of the operation surface 111 and is axially supported in a direction along the operation surface 111 within the casing 110. For example, when an operating point on an outer peripheral surface of the scroll wheel 120 is rotated to one side in the rotational direction, the set temperature of the air conditioning wind is changed to be higher. On the other hand, when the operating point of the scroll wheel 120 is rotated to the other side in the rotational direction, the set temperature of the air conditioning wind is changed to be lower.

A cylinder portion 121 is provided on the inner peripheral surface of the scroll wheel 120. The cylinder portion 121 is a bottomed cylindrical member, and a bottom surface of the cylinder portion 121 is located on one axial side of the scroll wheel 120. The cylinder portion 121 is inserted into the ring-shaped scroll wheel 120, and an outer peripheral surface of the cylinder portion 121 is fixed to an inner peripheral surface of the scroll wheel 120. The inner peripheral surface of the cylinder portion 121 forms an inner peripheral surface of the scroll wheel 120.

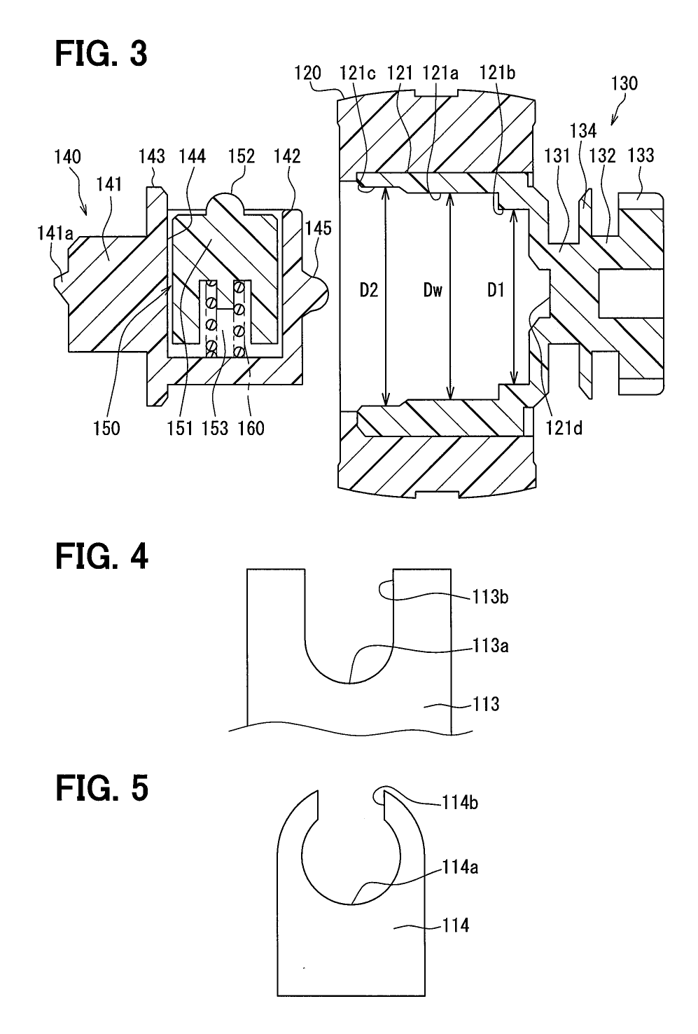

A length of the cylinder portion 121 in the axial direction is set to be equal to or slightly shorter than a length of the scroll wheel 120 in the axial direction. On the inner peripheral surface of the cylinder portion 121, a corrugated portion 121a is provided at an intermediate position in the axial direction. The corrugated portion 121a forms a click mechanism, and is a recess-protrusion portion continuous in a circumferential direction of the cylinder portion 121 like an internally toothed gear. An inner diameter (corrugated inner diameter) of the corrugated portion 121a is a dimension Dw (FIG. 3).

On the inner peripheral surface of the cylinder portion 121, a first sliding surface 121b is formed on the rotational shaft 130 side of the corrugated portion 121a. The first sliding surface 121b is a surface that is supported by the first receiving portion 142 (outer peripheral surface) of the fixed shaft 140 and rotationally slides on the first receiving portion 142. An inner diameter (first inner diameter) of the first sliding surface 121b is a dimension D1 (FIG. 3).

In addition, a second sliding surface 121c is formed on a side of the corrugated portion 121a opposite to the rotational shaft 130 side on the inner peripheral surface of the cylinder portion 121. The second sliding surface 121c is a surface that is supported by a second receiving portion 143 (outer peripheral surface) of the fixed shaft 140, and rotationally slides on the second receiving portion 143. An inner diameter (second inner diameter) of the second sliding surface 121c is a dimension D2 (FIG. 3).

In the present embodiment, the corrugated inner diameter Dw, the first inner diameter D1, and the second inner diameter D2 are set so as to satisfy a relationship of (first inner diameter D1)<(corrugated inner diameter Dw)<(second inner diameter D2). In other words, the inner diameter is set to decrease sequentially from the opening side to the bottom surface side of the cylinder portion 121.

A recess portion 121d that is recessed toward the rotational shaft 130 side is provided at a center position of the bottom surface of the cylinder portion 121. A protrusion portion 145 of the fixed shaft 140 enters the recess portion 121d.

The rotational shaft 130 is a member that is fixed to one axial side of the scroll wheel 120, in other words, to a center position of the bottom surface of the cylinder portion 121 fixed to the scroll wheel 120. The rotational shaft 130 rotates together with the scroll wheel 120 and the cylinder portion 121. The rotational shaft 130 includes a first shaft portion 131, a second shaft portion 132, a gear portion 133, a flange portion 134, and the like. The first shaft portion 131, the second shaft portion 132, the gear portion 133, and the flange portion 134 are an integrally molded article made of a resin material together with the cylinder portion 121.

The first shaft portion 131 is an axis that extends from the center position of the bottom surface of the cylinder portion 121. The second shaft portion 132 is a shaft that is coaxially connected to the first shaft portion 131 and is set to be larger in diameter than the first shaft portion 131.

The gear portion 133 functions as an output gear that is connected to a tip portion of the second shaft portion 132 and outputs a rotational force of the scroll wheel 120. For example, a rotation detection mechanism is connected to the gear portion 133 so as to detect a rotational state (rotation direction, rotation amount, and so on) of the scroll wheel 120. A thinned portion 133a for restricting the teeth from being shrunk during resin molding is provided in a center region of the gear portion 133.

The flange portion 134 is a disk-shaped member that is provided between the scroll wheel 120 and the gear portion 133 on the rotational shaft 130. In this example, the flange portion 134 is provided between the first shaft portion 131 and the second shaft portion 132. An outer diameter of the flange portion 134 is set to be larger than an outer diameter of the gear portion 133. The flange portion 134 is a member corresponding to the blocking portion of the present disclosure and is configured to restrict foreign matter, which enters from the gap 112a, from moving toward the gear portion 133.

A dimension between the bottom surface of the cylinder portion 121 (axial end portion of the scroll wheel 120) and the flange portion 134 is set to be slightly larger than a thickness dimension of the support wall 113. The support wall 113 is interposed between the bottom surface of the cylinder portion 121 and the flange portion 134. Therefore, an axial position of the rotational shaft 130 (the first shaft portion 131) is regulated relative to the support wall 113 by using the bottom surface of the cylinder portion 121 and the flange portion 134.

The fixed shaft 140 is a member that has an axial part inserted into the interior of the scroll wheel 120 (the inside of the cylinder portion 121) and rotationally supports the scroll wheel 120, the cylinder portion 121, and the rotational shaft 130 while being non-rotational. The fixed shaft 140 includes a fixed portion 141, a first receiving portion 142, a second receiving portion 143, a hole portion 144, a protrusion portion 145, and the like.

The fixed portion 141 is a portion to be fixed to the support wall 115 and is in, for example, a quadrangular sectional shape. A locking claw 141a is provided at an axial end portion of the fixed portion 141. One or more surfaces of the outer peripheral surface of the fixed portion 141 abuts against an abutment surface provided on the support wall 115 so as to restrict the fixed portion 141 from rotating around the axis. The locking claw 141a is locked in the locking hole 115a. A radial dimension (in this example, a dimension of one side of the quadrilateral cross section) of the fixed portion 141 is set to be smaller than an inner diameter (second inner diameter D2) of the cylinder portion 121.

The first receiving portion 142 is provided at a position corresponding to the first sliding surface 121b of the cylinder portion 121 at a tip portion opposite to the fixed portion 141. The first receiving portion 142 is in a circular cross-sectional shape and receives the first sliding surface 121b (first inner diameter D1) on the outer peripheral surface.

The second receiving portion 143 is provided at a position corresponding to the second sliding surface 121c of the cylinder portion 121 between the fixed portion 141 and the first receiving portion 142. The second receiving portion 143 is in a circular cross-sectional shape and receives the second sliding surface 121c (second inner diameter D2) on the outer peripheral surface. An outer diameter of the second receiving portion 143 is set to be larger than the outer diameter of the first receiving portion 142, and is formed in a disk shape. A columnar portion having the same outer diameter as that of the first receiving portion 142 is formed between the first receiving portion 142 and the second receiving portion 143.

In the columnar portion, the hole portion 144 is a portion that is recessed deeply from a predetermined outer peripheral surface position corresponding to the corrugated portion 121a of the cylinder portion 121 beyond an imaginary center line position (center position) so as to produce a predetermined bottom plate thickness with respect to an outer peripheral surface on the opposite side. A lubricant (grease or the like) for improving the slidability of the click pin 150 may be applied on an inner peripheral surface of the hole portion 144.

The protrusion portion 145 is provided at a tip portion of the fixed shaft 140 on the rotational shaft 130 side and enters the recess portion 121d of the cylinder portion 121.

The position of the fixed shaft 140 in the axial direction is regulated between the support wall 115 and the recess portion 121d of the cylinder portion 121.

The click pin 150 forms the click mechanism in cooperation with the corrugated portion 121a, and includes a main body portion 151, a protrusion portion 152, a thinned portion 153, and the like.

The main body portion 151 is formed in a cylindrical shape, and an axial dimension of the main body portion 151 is set to be somewhat smaller than a depth dimension of the hole portion 144 so that the main body portion 151 is slidable by an amount corresponding to a corrugation height of the corrugated portion 121a. The axial length of the main body portion 151 is set to be larger than an outer diameter of the main body portion 151 and is formed to be elongated in the axial direction.

Further, the protrusion portion 152 is provided on the opening side of the hole portion 144 in the main body portion 151. For example, the protrusion portion 152 is formed in a spherical shape on the front end side so as to enter an inside of a trough of the corrugated portion 121a.

The thinned portion 153 is thinned on a side of the main body portion 151 opposite to the protrusion portion 152 and defines a space in which the spring 160 is accommodated.

The spring 160 is an elastic member, for example, formed of a coil spring, and is accommodated in the thinned portion 153 of the click pin 150 so as to impart an urging force against the click pin 150 toward the corrugated portion 121a side.

The corrugated portion 121a, the hole portion 144, the click pin 150, and the spring 160 form the click mechanism which gives a click feeling to the occupant when the occupant rotates the scroll wheel 120.

The display device 170 displays an input state corresponding to the rotational operation of the scroll wheel 120, and is located adjacent to a back side of the operation surface 111 on the other axial side of the scroll wheel 120. In this example, as shown in FIG. 2, the display device 170 displays the changed set temperature of the air conditioning wind. The display device 170 is configured by, for example, a self-luminous display (organic EL display) having a flat plate shape. The display content (image) displayed on the display device 170 is visually recognized by the occupant through a light transmitting portion of the operation surface 111.

The operation surface 111 is provided with a switch unit 171 for changing (inputting) set values (setting conditions) of other control items of the air conditioning apparatus in a region of the scroll wheel 120 opposite to the display device 170. The switch unit 171 is, for example, an auto-(AUTO) switch for setting the operation state of the air conditioning apparatus to an automatic control state.

The operating device 100 according to the present embodiment is configured as described above, and the operation and effects of the operating device 100 will be described below.

When the occupant rotationally operates the protrusion portion of the scroll wheel 120 with a fingertip, the rotation of the scroll wheel 120 is transmitted to the gear portion 133 through the cylinder portion 121, and the first and second shaft portions 131 and 132 of the rotational shaft 130. At this time, the protrusion portion 152 of the click pin 150 enters a trough of the corrugated portion 121a formed in the cylinder portion 121 or is pushed out toward a crest side thereof, whereby the occupant can obtain the click feeling during the rotational operation.

The rotational states (rotation direction, rotation amount, and so on) of the scroll wheel 120 are detected with the rotation detection mechanism connected to the gear portion 133, and the set temperature of the air conditioning apparatus is changed according to the rotational states. At the same time, a display content (in this example, the displayed temperature of the air conditioning wind) on the display device 170 is switched to another. An instruction to the air conditioning apparatus (instruction to perform automatic control) is issued according to the input state to the switch unit 171.

In the present embodiment, the corrugated portion 121a is located on the inner peripheral surface of the ring-shaped scroll wheel 120 (cylinder portion 121), and the click pin 150 and the spring 160 are provided in the hole portion 144 of the fixed shaft 140 inserted into the cylinder portion 121. Therefore, the corrugated portion 121a, the click pin 150, and the spring 160 (click mechanism) can be located inside the scroll wheel 120, and no space is required for providing the click mechanism on the outside of the scroll wheel 120.

The hole portion 144 is formed deeply beyond the imaginary center line position of the fixed shaft 140. Therefore, the degree of freedom of setting the dimensions of the spring 160 and the click pin 150 in the depth direction of the hole can be increased. Therefore, the click pin 150 can be elongated along the depth direction of the hole portion 144 to increase a sliding area along the inner peripheral surface of the hole portion 144. This can make the click pin 150 less subject to falling off from the hole portion 144 at a stage before assembly. The fixed shaft 140 on which the click pin 150 is set can be easily assembled to the scroll wheel 120. Further, the degree of freedom of setting the dimension of the spring 160 can be increased. Therefore, an urging force on the click pin 150 by the spring 160 is easily set.

Generally, the operating device 100 provided with the click mechanism in the scroll wheel 120 is excellent in assembling property of the click mechanism and can give a favorable click feeling.

In addition, in the cylinder portion 121, the respective inner diameter dimensions are set to satisfy a relationship of “first inner diameter D1”<“corrugated portion inner diameter Dw”<“second inner diameter D2”. As a result, the inner diameter of the scroll wheel 120 (cylinder portion 121) can be configured such that the inner diameter decreases in order toward the rotational shaft 130 side as viewed from the opposite side of the rotational shaft 130. Therefore, when the fixed shaft 140 is inserted to the inner diameter side of the scroll wheel 120, the insertability can be improved because the scroll wheel 120 functions as a tapered guide (FIG. 3).

In the case where a lubricant such as grease is provided in the hole portion 144 to improve the slidability of the click pin 150, the portion (second receiving portion 143) of the fixed shaft 140 corresponding to the second sliding surface 121c serves as a lid member for closing the inner circumferential opening of the scroll wheel 120, so that the lubricant can be restricted from leaking to the outside.

Further, in the rotational shaft 130, the flange portion 134 is provided between the scroll wheel 120 and the gear portion 133. As a result, the foreign matter entering from the gap 112a can be restricted from adhering to the gear portion 133 by the flange portion 134. Therefore, the deterioration of the rotational feeling of the gear portion 133 and further operation malfunction or the like can be restricted.

In addition, the axial position of the rotational shaft 130 is regulated with respect to the supporting wall 113 by the axial end portion of the scroll wheel 120 and the flange portion 134. Accordingly, the flange portion 134 can also serve as a positioning member in the axial direction of the rotational shaft 130.

### Second Embodiment

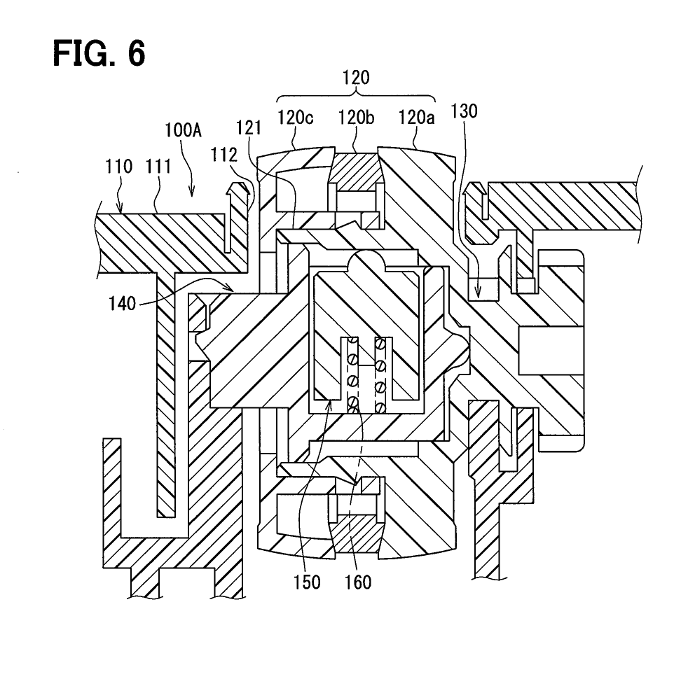

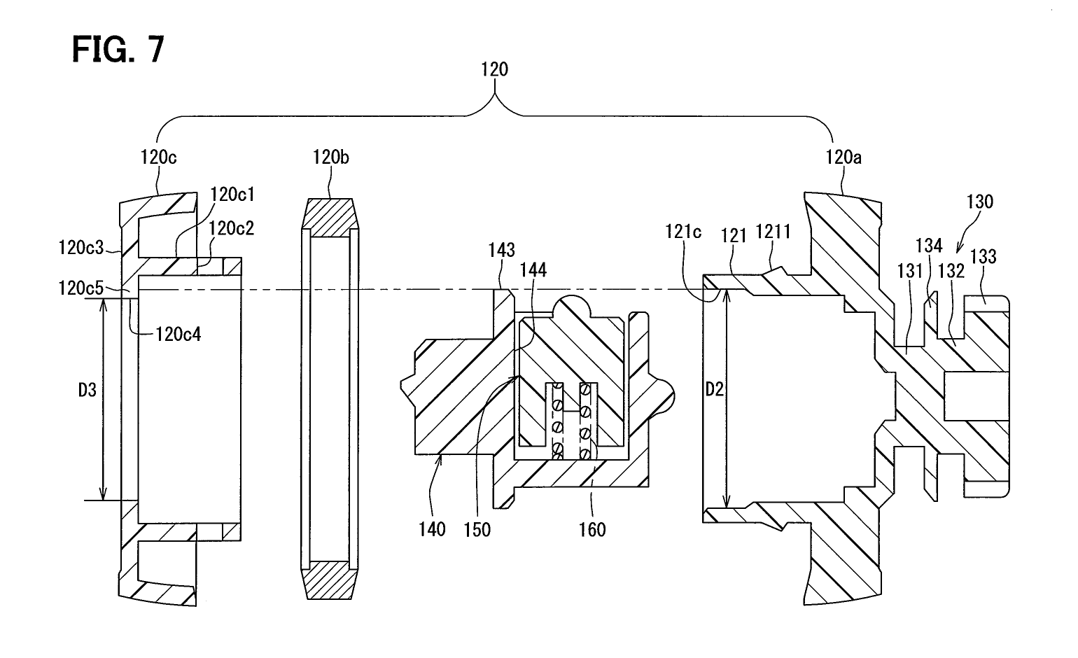

FIGS. 6 and 7 show an operating device 100A according to a second embodiment. The operating device 100A according to the second embodiment is different from the operating device 100 of the first embodiment in the structure of the scroll wheel 120 and the rotational shaft 130.

The scroll wheel 120 is formed as an assembly of multiple components. The multiple components include a first wheel 120a, a second wheel 120b, and a third wheel 120c.

The first wheel 120a is a ring-shaped member that is located on one axial side of the scroll wheel 120. The first wheel 120a is made of a resin material, and is formed integrally with a cylinder portion 121 made of a resin on one axial side of the cylinder portion 121. In other words, the first wheel 120a and the cylinder portion 121 are formed into an integrally molded component made of a resin material. A predetermined number of locking claws 1211 to be locked in the locking holes 120c2 of the third wheel 120c, which will be described later, are provided in a circumferential direction at an axially intermediate position of the outer peripheral surface of the cylinder portion 121. The surface of the first wheel 120a is painted with a predetermined color. The painting can be gloss painting, matte painting or the like.

The second wheel 120b is a ring-shaped member that is located in an axially intermediate region of the scroll wheel 120. The second wheel 120b is made of a resin material or a metal material. In the case where the second wheel 120b is made of resin, for example, the surface of the second wheel 120b is coated with metallic luster. Also, when the second wheel 120b is made of metal (for example, made of aluminum), the surface has a metallic base gloss.

The third wheel 120c is a ring-shaped member that is located on the other axial side of the scroll wheel 120. The third wheel 120c is made of a resin material, and the surface of the third wheel 120c is painted with a predetermined color. The painting can be gloss painting, matte painting or the like.

The second wheel 120b side of the third wheel 120c is hollow, and a portion forming the inner peripheral side of the ring shape is a cylinder portion 120c1 in a cylindrical shape. A predetermined number of locking holes 120c2 for locking the locking claws 1211 are provided in the circumferential direction on the first wheel 120a side of the cylinder portion 120c1. Furthermore, an end portion of the third wheel 120c toward a center position of an outer wall portion 120c3 adjacent to the opening portion 112 is an extension portion 120c5 that extends toward the axis center side of the scroll wheel 120 from the second inner diameter D2 position of the cylinder portion 121, and forms a circular opening 120c4. An opening inner diameter D3 of the opening portion 120c4 is set to be smaller (about several mm) than the second inner diameter D2 of the cylinder portion 121. In other words, the extension portion 120c5 of the outer wall portion 120c3 covers a line (radially inner line) of the second inner diameter D2.

The first to third wheels 120a to 120c and the fixed shaft 140 are assembled together as shown in FIG. 7. First, the fixed shaft 140 to which the click pin 150 is assembled is inserted into the first wheel 120a. A lubricant (grease or the like) for improving the slidability of the click pin 150 is applied to an inner peripheral surface of the hole portion 144 of the fixed shaft 140.

Next, the second wheel 120 b is located so as to pass from the fixed shaft 140 side through the outer peripheral side of the cylinder portion 121 and abut against the first wheel 120a. Then, the third wheel 120c is assembled to the cylinder portion 121 from the fixed shaft 140 side. At that time, the second wheel 120b is interposed and fixed between the first wheel 120a and the third wheel 120c. Further, an inner peripheral surface of a cylinder portion 120c1 of the third wheel 120c is inserted so as to abut against an outer peripheral surface of the cylinder portion 121, and the locking claw 1211 is locked by a locking hole 120c2. As a result, the third wheel 120c is fixed to the first wheel 120a (cylinder portion 121).

In the present embodiment, the scroll wheel 120 is formed as an assembly of multiple components, that is, the first to third wheels 120a to 120c. The three components can be set with different colors, gloss, or the like, thereby being capable of making the scroll wheel 120 rich in design.

As described in the first embodiment, the second receiving portion 143 of the fixed shaft 140 functions as a lid member that closes the inner circumferential opening of the scroll wheel 120 with respect to the second sliding surface 121c of the cylinder portion 121. In addition, an extension portion 120c5 of an outer wall portion 120c3 of the third wheel 120c covers a line of the second sliding surface 121c (second inner diameter D2). Therefore, the lubricant can be further restricted from leaking to the outside.

In addition, the extension portion 120c5 of the outer wall portion 120c3 performs a function of restricting the fixed shaft 140 from coming off, and the fixed shaft 140 does not fall off from the cylinder portion 121 after assembly.

In addition, the first wheel 120a and the cylinder portion 121 are integrated together. Therefore, a click vibration (click feeling) by the click pin 150 is directly transmitted to the first wheel 120a, thereby being capable of improving a feeling obtained by the click vibration.

### Third Embodiment

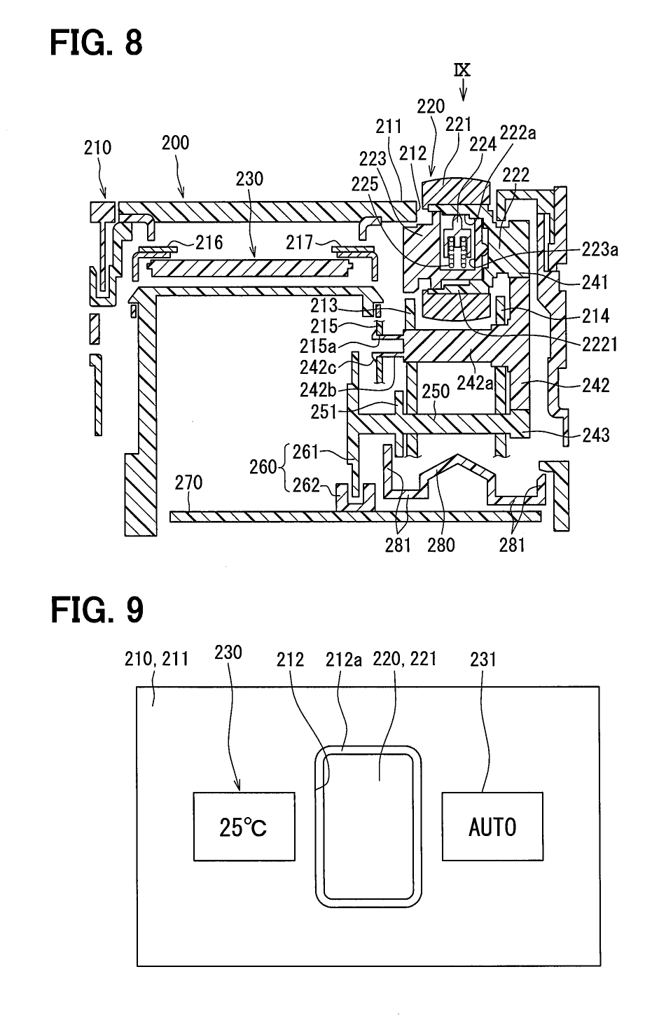

An operating device 200 according to a third embodiment will be described with reference to FIGS. 8 and 9. The operating device 200 is, for example, a device for changing (inputting) a set value of a predetermined control item in a vehicle air conditioning apparatus, and is provided in a center console of the vehicle. In this case, the operating device 200 changes, for example, the setting of a temperature of an air conditioning wind as a predetermined control item. The operating device 200 includes a casing 210, a scroll wheel 220, a display device 230, a first gear 241, a second gear 242, a third gear 243, a shaft portion 250, a rotation detection mechanism 260, a circuit board 270, an illumination unit 280, and so on.

The casing 210 is a box-shaped member that accommodates the respective components forming the operating device 200 inside and has an operation surface 211, an opening portion 212, support walls 213 and 214, a blocking wall 215, support portions 216 and 217, and so on.

The operation surface 211 is a surface of the casing 210 on an operator (hereinafter, referred to as occupant) side and forms an operating panel for air conditioning. Basically, for example, a surface of the operation surface 211 is painted with a light-shielding paint and functions as a light shielding portion. However, a region of the operation surface 211 corresponding to the display device 230 is a portion not painted with a light-shielding paint and functions as a light transmission portion.

The opening portion 212 is a hole for allowing a part of the scroll wheel 220 to protrude toward the occupant side. A gap 212a is provided between the opening portion 212 and the scroll wheel 220 around the opening portion 212.

The support walls 213 and 214 are provided in the casing 210, and each formed with a wall surface in a direction intersecting with the operation surface 211. The support walls 213 and 214 are wall portions for rotationally supporting the shaft portion 242a of the second gear 242 and the shaft portion 250 of the third gear 243.

The locking wall 215 is a wall portion located adjacent to the support wall 213, and is provided with an elastic portion 242b of the shaft portion 242a and a locking hole 215a through which the locking claw 242c is inserted.

The support portions 216 and 217 are components for fixedly supporting the display device 230 on one axial side of the scroll wheel 220 and on a back side of the operation surface 211.

The scroll wheel 220 partially protrudes from the opening portion 212 and is axially supported in a direction along the operation surface 211 within the casing 210. The scroll wheel 220 serves as an input switch unit for setting the temperature of the air conditioning wind by the rotation operation by the occupant. For example, when an operating point of the scroll wheel 220 is rotated upward in FIG. 9, the temperature of the air conditioning wind is set to be higher. On the other hand, when the operating point of the scroll wheel 220 is rotated downward in FIG. 9, the temperature of the air conditioning wind is set to be lower. The scroll wheel 220 has a main body portion 221, a rotational shaft 222, a fixed shaft 223, a click pin 224, a spring 225, and so on.

The main body portion 221 is rotationally operated by the occupant, and is formed in a ring shape.

The rotational shaft 222 is a shaft portion that supports the main body portion 221 in the casing 210 in a direction along the operation surface 211, and extends from the inside (the inner peripheral side portion) of the main body portion 221 to a side opposite to the display device 230 in the axial direction. The rotational shaft 222 is fixed to the inner peripheral surface of the main body portion 221 and rotates together with the main body portion 221. A region of the rotational shaft 222 corresponding to the main body portion 221 is a cylinder portion 2221 that opens toward the display device 230. An inner peripheral surface of the cylinder portion 2221 forms an inner peripheral surface of the scroll wheel 220. A corrugated portion 222a forming the click mechanism is located on the inner peripheral surface of the cylinder portion 2221. The corrugated portion 222a is a recess-protrusion portion continuous in a circumferential direction of the cylinder portion 2221 like an internally toothed gear.

The fixed shaft 223 rotationally supports the main body portion 221 and the rotary shaft 222, one axial side of the fixed shaft 223 is fixed between the operation surface 211 and the support wall 213, and the opposite side of the fixed shaft 223 is inserted into the inside of the cylinder portion 2221 of the rotational shaft 222. A portion of the fixed shaft 223 which is inserted into the cylinder portion 2221 is provided with a hole portion 223a that is recessed toward the inner side in a direction intersecting with the axial direction from a predetermined surface side in the circumferential direction so as to correspond to the corrugated portion 222a.

The click pin 224 is a member that forms the click mechanism in association with the corrugated portion 222a, and a tip portion of the click pin 224 is formed in a spherical shape, for example, and the other end side of the click pin 224 is formed in a cylindrical shape. The click pin 224 is inserted into the hole portion 223a so that the tip portion of the click pin 224 abuts against the corrugated portion 222a.

The spring 225 is an elastic member that forms the click mechanism in association with the corrugated portion 222a and the click pin 224. The spring 225 is interposed between the click pin 224 and the bottom of the hole portion 223a, and applies an urging force against the click pin 224 toward the corrugated portion 222a side.

The display device 230 displays an input state corresponding to the rotation operation of the scroll wheel 220, and is located adjacent to a back side of the operation surface 211 on one axial side of the scroll wheel 220. In this example, as shown in FIG. 9, the display device 230 displays the changed set temperature of the air conditioning wind. The display device 230 is configured by, for example, a self-luminous display (organic EL display) having a flat plate shape.

The display content (image) displayed on the display device 230 is visually recognized by the occupant through a light transmitting portion of the operation surface 211.

The operation surface 211 is provided with a switch unit 231 for changing (inputting) set values (setting conditions) of other control items of the air conditioning apparatus in a region of the scroll wheel 220 opposite to the display device 230. The switch unit 231 is, for example, an automatic (AUTO) switch for setting the operation state of the air conditioning apparatus to an automatic control state. The switch unit 231 outputs an input signal, when an input operation is performed by the occupant, to the circuit board 270.

The first gear 241 is a spur gear fixed to the side opposite to the display device 230 on the rotational shaft 222 of the scroll wheel 220 and rotates together with the rotational shaft 222. The first gear 241 is a reference gear for the second gear 242 and the third gear 243. The number of teeth in the first gear 241 is set to 24, for example.

The second gear 242 is a spur gear that is located on the side of the first gear 241 away from the operation surface 211, meshes with the first gear 241, and rotates at a reduced speed with respect to the first gear 241. The number of teeth of the second gear is set to 48, for example, and a diameter of the second gear 242 is twice as large as a diameter of the first gear 241.

A shaft portion 242a that rotates together with the second gear 242 is fixed to the second gear 242. The shaft portion 242a extends from the second gear 242 to the display device 230 side. Two elastic portions 242b that are thinned and face each other in the radial direction are provided on the front end side of the shaft portion 242a. The elastic portion 242b is elastically deformable in the radial direction. Further, a locking claw 242c that protrudes outward in the radial direction is provided at the most front end portion of the elastic portion 242b.

The elastic portion 242b and the locking claw 242c are inserted into the locking hole 215a of the locking wall 215 and the locking claw 242c is locked to a periphery of the locking hole 215a, thereby to restrict the shaft portion 242a from slipping out in the axial direction. Furthermore, the shaft portion 242a is rotationally axially supported by the support walls 213 and 214 at two axial positions excluding regions where the elastic portion 242b and the locking claw 242c are formed.

The third gear 243 is a spur gear that is located on the side of the second gear 242 away from the operation surface 211, meshes with the second gear 242, and rotates at an increased speed with respect to the first gear. The number of teeth of the third gear is set to 12, for example, and a diameter of the third gear 243 is ½ as large as the diameter of the first gear 241.

The shaft portion 250 is fixed to the third gear 243, and rotates together with the third gear 243. The shaft portion 250 extends from the third gear 243 to the display device 230 side. The shaft portion 250 is rotationally supported by the support walls 213 and 214 at two positions in the axial direction. The shaft portion 250 corresponds to a gear shaft of the present disclosure.

A disk-shaped flange portion 251 is located in a portion between the support wall 213 and the rotation detection mechanism 260 (rotational plate 261) at the intermediate portion of the shaft portion 250. The flange portion 251 restricts foreign matter entering from the gap 212a around the scroll wheel 220 from moving to the rotation detection mechanism 260 (in particular, photo-interrupter 262) side. The flange portion 251 corresponds to a blocking portion for restricting the foreign matter according to the present disclosure.

The rotation detection mechanism 260 detects the rotational state of the scroll wheel 220 being rotationally operated, and has a rotational plate 261 and a photo interrupter 262.

The rotational plate 261 is a disk-shaped member having a predetermined outer diameter dimension, and is fixed to an end portion of the shaft portion 250 on the display device 230 side. Therefore, the rotational plate 261 rotates through the first to third gears 241 to 243 and the shaft portion 250 in association with the rotation operation of the scroll wheel 220.

On the outer circumferential portion of the rotational plate 261, multiple light-shielding teeth are provided so as to be aligned in the circumferential direction at predetermined intervals, and the rotational plate 261 is formed like a spur gear. The light shielding teeth of the rotational plate 261, for example, have a rectangular shape, and serve as light shielding portions for shielding light in the axial direction of the rotational plate 261. Further, spaces between the respective light-shielding teeth are slit portions which allow the light in the axial direction of the rotational plate 261 to pass through. The dimension in the circumferential direction of the light shielding portions (teeth) and the dimension in the circumferential direction of the slit portions are set to be the same.

The photo interrupter 262 is a detection unit that detects the rotational state of the rotational plate 261 to detect the rotational states (the direction and amount of rotation) of the scroll wheel 220. The photo-interrupter 262 is located on the radially outside of the rotational plate 261 so as to correspond to a predetermined position in the circumferential direction, and is fixed to the operation surface 211 side of the circuit board 270.

The photo interrupter 262 has a light emitting portion for generating light and two light receiving portions for receiving the light from the light emitting portion to generate a received light signal. For example, an infrared type light emitting diode is used as the light emitting portion. Further, for example, phototransistors or photo ICs are used as the two light receiving portions.

The light emitting portion is located on one axial side of the rotational plate 261, and the two light receiving portions are located on the other axial side of the rotational plate 261 so as to correspond to the light emitting portion. The two light receiving portions are located so as to be aligned in the circumferential direction of the rotational plate 261. The two light receiving portions are located adjacent to each other, and a distance (pitch P) between both of the light receiving portions is set to be smaller than the circumferential dimensions of the light shielding portions (teeth) and the slit portions.

The light shielding portions (teeth) and the slit portions of the rotational plate 261 are located between the light emitting portion and the two light receiving portions. In other words, when the rotational plate 261 is rotated, the light shielding portions (teeth) and the slit portions alternately pass between the light emitting portion and the two light receiving portions. A case where the light from the light emitting portion passes through the slit portions and is received by both of the light receiving portions and a case where the light from the light emitting portion is blocked by the light shielding portions (teeth) and not received by both of the light receiving portions are repeatedly generated. The received light signals (detection signals) at the two light receiving portions are output to the circuit board 270.

It should be noted that the photo interrupter 262 is not limited to a configuration in which one light emitting portion and two light receiving portions are provided, but two (a pair of) photo interrupters each having one light emitting portion and one light receiving portion may be provided.

In this example, the circumferential dimensions of the light shielding portions (teeth) and the slit portions of the rotational plate 261 are appropriately set with respect to the light emitting portion and the light receiving portions of the photo interrupter 262, which allows the photo interrupter 262 to accurately grasp the direction and amount of rotation.

For that purpose, it is preferable to increase the amount of movement of the outer circumferential portion of the rotational plate 261 during rotation. The amount of movement of the outer circumferential portion of the rotational plate 261 increases with increasing diameter or rotation speed of the rotational plate 261. Therefore, the dimensions of the light shielding portions (teeth) and the slit portions of the rotational plate 261 are easily set when the diameter of the rotational plate 261 is set large to a certain extent (predetermined outer diameter dimension) or/and when the third gear 243 of the shaft portion 250 of the rotational plate 261 is used as a speed increasing gear to increase the rotation speed of the rotational plate 261 so that the amount of movement is increased.

The circuit board 270 is a plate-shaped member provided with a control circuit, is located on a side away from the operation surface 211 relative to the rotation detection mechanism 260 (rotational plate 261, photo interrupter 262), and is provided in parallel to the operation surface 211. The circuit board 270 reads the received light signals from the two light receiving portions and detects the direction and amount of rotation of the rotational plate 261, that is, the scroll wheel 220 based on a generation pattern of the received light signal. Then, the circuit board 270 controls the switching of the display content (displayed temperature of the air conditioning wind) on the display device 230 according to the direction and amount of rotation.

It should be noted that the circuit board 270 issues an instruction to the air conditioning apparatus so as to provide the control content assigned to the switch unit 231 according to the input state of the switch unit 231. Here, when the switch unit 231 is pressed, the circuit board 270 issues an instruction to perform automatic control (auto control) to the air conditioning apparatus, and when the switch unit 231 is pushed again, the circuit board 270 issues an instruction to cause the air conditioning apparatus to cancel the automatic control (to perform a manual control).

The illumination unit 280 illuminates the gap 212a around the scroll wheel 220 and is provided on the operation surface 211 side of the circuit board 270 at a position facing the scroll wheel 220. Each illumination unit 280 includes a light source unit and a plate-shaped lens portion or the like which lets the light out from the light source unit toward the gap 212a. For example, the illumination unit 280 is turned on during nighttime drive to illuminate the gap 212a and indicate the position of the scroll wheel 220 to the occupant.

A water receiving portion 281 for storing the water entering from the gap 212a before it reaches the circuit board 270 and for discharging the water into a predetermined region is provided in each illumination unit 280. The water receiving portion 281 is located on the operation surface 211 side of the circuit board 270 together with the illumination unit 280. The water entering from the gap 212a occurs, for example, when the occupant has mistakenly spilled tea, juice, or the like on the operation surface 211. For example, the water receiving portion 281 includes, for example, a receiving portion extending along a plate surface of the circuit board 270 from an end portion of the plate-shaped lens portion, a dam portion rising from the end of the receiving portion to the operation surface 211 side, and a discharge portion (drain pipe) for discharging the water stored in the receiving portion to a predetermined region.

The operating device 200 according to the present embodiment is configured as described above. Hereinafter, the operation and effects of the operating device 200 will be described.

When the occupant rotationally operates the protrusion portion of the scroll wheel 220 with a fingertip, the rotation of the scroll wheel 220 is transmitted to the first gear 241 through the rotational shaft 222. At this time, the tip portion of the click pin 224 enters the recess portion of the corrugated portion 222a formed in the rotational shaft 222 or is pushed out toward the protrusion portion side of the corrugated portion 222a, whereby the occupant can obtain the click feeling during the rotation operation.

Then, the rotation of the scroll wheel 220 transmitted to the first gear 241 is transmitted to the rotational plate 261 through the second gear 242, the third gear 243, and further the shaft portion 250. With the rotation of the rotational plate 261, a received light signal in the photo interrupter 262 is output to the circuit board 270. The circuit board 270 detects the direction and amount of rotation of the rotational plate 261, that is, the scroll wheel 220, from the received light signal. Then, the circuit board 270 switches the display content (in this example, displayed temperature of the air conditioning wind) on the display device 230 according to the direction and amount of rotation. The circuit board 270 issues an instruction to the air conditioning apparatus (instruction to perform automatic control) according to the input state to the switch unit 231.

According to the present embodiment, the display device 230 is located adjacent to one axial side of the scroll wheel 220 on the operation surface 211. In addition, the first to third gears 241 to 243 are located in order on an axial side of the scroll wheel 220 opposite to the display device 230 in a direction away from the operation surface 211. The rotational plate 261 is fixed to the display device 230 side of the shaft portion 250 of the third gear 243, and is rotated through the first to third gears 241 to 243 and the shaft portion 250.

In this example, the second gear 242 is a reduction gear relative to the first gear 241. Therefore, an outer diameter of the second gear 242 is set to be larger than an outer shape of the first gear 241, so that an inter-axis distance between the first gear 241 and the third gear 243 can be set to be larger. The third gear 243 is a speed increasing gear relative to the first gear 241. Therefore, a rotating speed of the rotational plate 261 does not become smaller than a rotating speed of the scroll wheel 220. In other words, the amount of rotation (the amount of movement) of the rotational plate 261 at the outer circumferential portion can be appropriately ensured relative to the amount of rotation of the scroll wheel 220, which restricts an issue in detecting the rotational state of the rotational plate 261 by the photo interrupter 262 on the radially outside of the rotational plate 261.

The inter-axis distance between the first gear 241 and the third gear 243 can be set to be larger. Therefore, the rotational plate 261 does not interfere with the display device 230, even if the rotational plate 261 is located on the axial display device 230-side of the scroll wheel 220. In other words, the display device 230 can be easily set adjacent to the scroll wheel 220.

In addition, the display device 230 is a self-luminous type display. When the display device 230 is a self-luminous type display, there is no need to provide a light source unit separate from the display unit, and the display device 230 can emit light for display, independently. For the display unit requiring the light source unit, there is a need to pay attention so that the light from the light source unit does not interfere with the rotational plate 261. On the other hand, for the display device 230 using the self-luminous type display, such attention is unnecessary, and a favorable display state of the display device 230 can be easily ensured.

Further, the shaft portion 250 is provided with a flange portion 251 as a blocking portion. As a result, foreign matter entering from the gap 212a around the scroll wheel 220 can be restricted from reaching the photo interrupter 262, so that a reduction in the sensitivity of the photo interrupter 262 due to the foreign matter can be restricted.

Further, the photo interrupter 262 is fixed to the operation surface 211 side of the circuit board 270. As a result, the photo interrupter 262 using the circuit board 270 can be fixed without the provision of a dedicated board for fixing the photo interrupter 262.

Further, the water receiving portion 281 is provided in the illumination portions 280. As a result, the water entering from the gap 212a around the scroll wheel 220 is stored in the water receiving portion 281, so that the water does not directly reach the circuit board 270 and a trouble with the circuit board 270 due to exposure to water can be restricted. The water stored in the water receiving portion 281 is discharged to a predetermined region by a discharge portion. Therefore, the water is restricted from overflowing in the water receiving portion and reaching the circuit board 270.

In addition, the shaft portion 242a is axially supported in a region excluding the region where the elastic portion 242b is provided. As a result, the shaft portion 242a is axially supported without being affected by the elastic deformation of the elastic portion 242b, so that the shaft portion does not undergo vibration or the like during operation.

### Fourth Embodiment

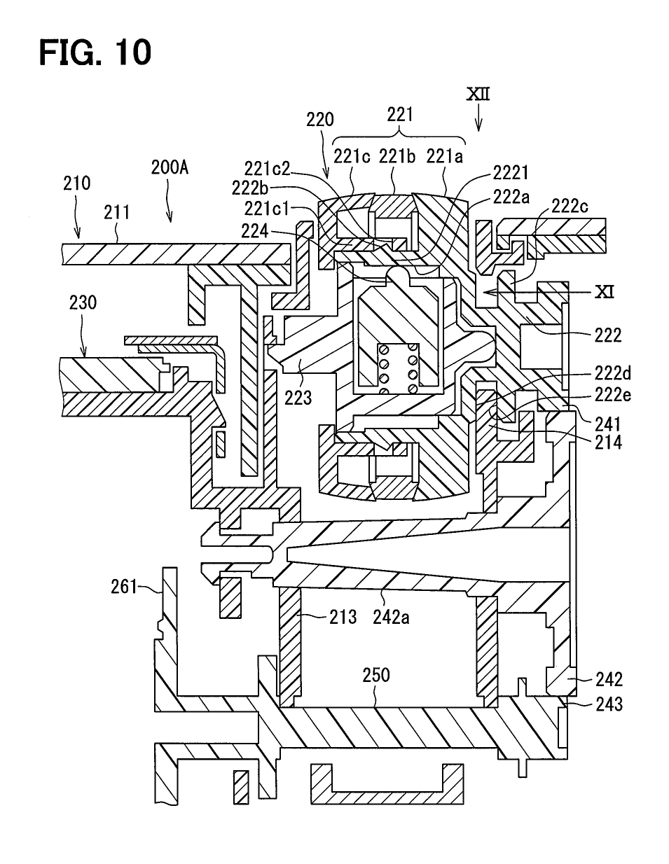

FIGS. 10 to 13 show an operating device 200A according to a fourth embodiment. The operating device 200A according to the fourth embodiment is different from the operating device 200 of the third embodiment in that a meshing mode of the first to third gears 241 to 243 is changed, a structure of the scroll wheel 220 is changed, and a rotation direction display unit 232 is added. In the present embodiment, the scroll wheel 220 and the first to third gears 241 to 243 are made of resin and are formed using a mold.

For the first to third gears 241 to 243, the mold dividing line is set around the axial end portion during the molding, and thus minute burrs can be generated around the axial end portion. Therefore, in the present embodiment, as shown in FIG. 10, the first gear 241, the second gear 242, and the third gear 243 are arranged such that the mutually meshed teeth are shifted in the axial direction and the axial end portions of the teeth are non-contact with each other.

The main body portion 221 of the scroll wheel 220 is formed as an assembly of multiple components. The multiple components include a first wheel 221a, a second wheel 221b, and a third wheel 221c.

The first wheel 221a is a ring-shaped member that forms the rotational shaft 222 side of the main body portion 221 in the axial direction. The first wheel 221a is integrally formed with the cylinder portion 2221 on the rotational shaft 222 side of the cylinder portion 2221 made of resin. In other words, the first wheel 221a and the cylinder portion 2221 are formed into an integrally molded component made of a resin material. A predetermined number of locking claws 222b to be locked in the locking holes 221c2 of the third wheel 221c, which will be described later, are provided in a circumferential direction at an axially intermediate position of the outer peripheral surface of the cylinder portion 2221. The surface of the first wheel 221a is painted with a predetermined color. The painting can be gloss painting, matte painting or the like.

The second wheel 221b is a ring-shaped member that forms an axially intermediate region of the main body portion 221. The second wheel 221b may be made of a metal material with respect to the resin material. In the case where the second wheel 221b is made of resin, for example, the surface of the second wheel 221b is coated with metallic luster. Also, when the second wheel 221b is made of metal (for example, made of aluminum), the surface has a metallic base gloss.

The third wheel 221c is a ring-shaped member that forms the fixed shaft 223 side of the main body portion 221 in the axial direction. The surface of the third wheel 221c is painted with a predetermined color. The painting can be gloss painting, matte painting or the like.

The second wheel 221b side of the third wheel 221c is hollow, and a portion forming the inner peripheral side of the ring shape is a cylinder portion 221c1 in a cylindrical shape. A predetermined number of locking holes 221c2 for locking the locking claws 222b are provided in the circumferential direction on the first wheel 221a side of the cylinder portion 221c1.

The first to third wheels 221a to 221c and the fixed shaft 223 are assembled together as described above. In other words, the fixed shaft 223 to which the click pin 224 is assembled is inserted into the first wheel 221a.

The second wheel 221b is located so as to pass from the fixed shaft 223 side through the outer peripheral side of the cylinder portion 2221 and abut against the first wheel 221a. Then, the third wheel 221c is assembled to the cylinder portion 2221 from the fixed shaft 223 side. The second wheel 221b is interposed and fixed between the first wheel 221a and the third wheel 221c. Further, an inner peripheral surface of a cylinder portion 221c1 of the third wheel 221c is inserted so as to abut against an outer peripheral surface of the cylinder portion 2221, and the locking claw 222b is locked to a locking hole 221c2. As a result, the third wheel 221c is fixed to the first wheel 221a (cylinder portion 2221).

A disk-shaped flange portion 222c is provided at the intermediate position of the rotational shaft 222. The flange portion 222c restricts foreign matter entering through a gap 212a from moving toward the first gear 241.

A portion of the first wheel 221a on the rotational shaft 222 side is an axial end surface of the scroll wheel 220. The axial end surface forms a sliding surface 222d. A surface of the flange portion 222c opposed to the sliding surface 222d is a sliding surface 222e. A dimension between the sliding surface 222d and the sliding surface 222e is set to be slightly larger than a thickness dimension of the support wall 214. The support wall 214 is interposed between the sliding surface 222d and the sliding surface 222e. Therefore, an axial position of the rotational shaft 222 (the scroll wheel 220) is regulated relative to the support wall 214 by the sliding surface 222d and the sliding surface 222e.

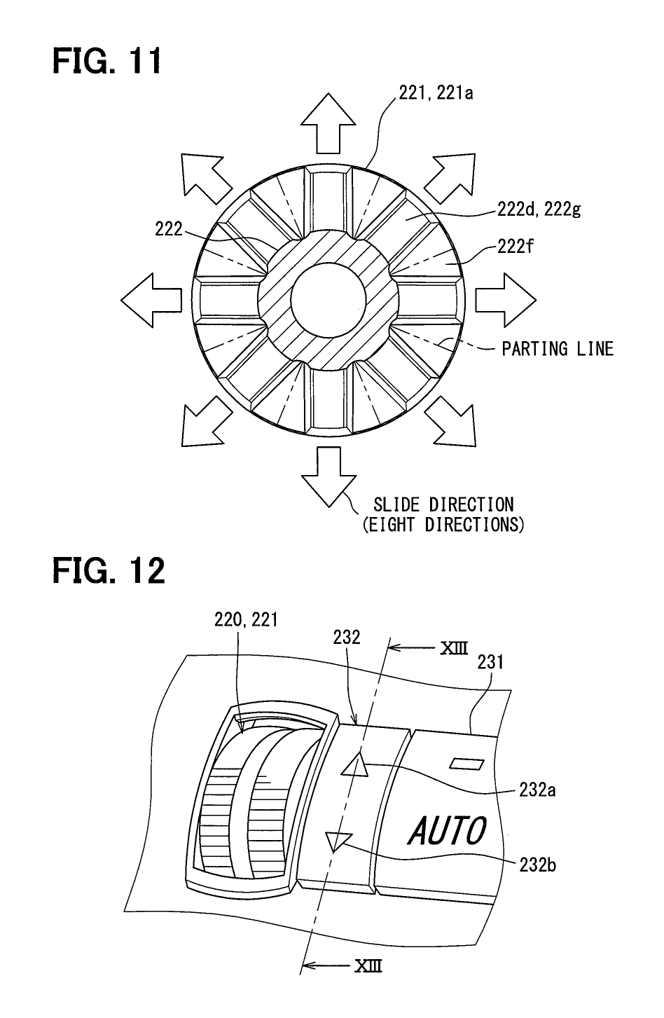

As shown in FIG. 11, the sliding surface 222d has recess portions 222f and protrusion portions 222g. The multiple protrusion portions 222g protrude toward the support wall 214 with respect to the recess portions 222f, and are located so as to extend radially from the center of the sliding surface 222e. In this example, eight protrusion portions 122g are provided. In the sliding surface 222d, each recess portion 222f forms a surface that is non-contact with the support wall 214, and the protrusion portions 222g substantially come in sliding contact with the support wall 214.

The flange portion 222c larger in diameter than the rotational shaft 222 and the first gear 241 are provided in the rotational shaft 222. During the molding, therefore, a slide mold is used, which slides in a direction intersecting with the axial direction. In this example, eight slide molds are used corresponding to the respective protrusion portions 222g, and a mating portion of each slide mold is positioned within a region of each recess portion 222f. The mating portion of each slide mold becomes a portion where minute burrs, so-called parting lines, can be generated. Therefore, in the present embodiment, the parting line associated with so-called molding is provided in the recess portion 222f on the sliding surface 222d.

Incidentally, it is preferable that the recess portions 222f in which the parting line is provided and the protrusion portions 222g serving as the sliding surfaces may also be formed on the surface of the flange portion 222c, which faces the support wall 214.

As shown in FIG. 12, a rotation direction display unit 232 is provided between the scroll wheel 220 and the switch unit 231. Triangular display marks 232a and 232b indicating the rotation direction (upper side and lower side in FIG. 12) of the scroll wheel 220 are provided in the rotation direction display unit 232. The display marks 232a and 232b are light transmitting portions which are not subjected to light shielding painting in the rotation direction display unit 232. For example, the display marks 232a and 232b are configured to emit light by light source portions 280a and light guide portions 280b, which will be described later, when a nighttime illumination switch is turned on.

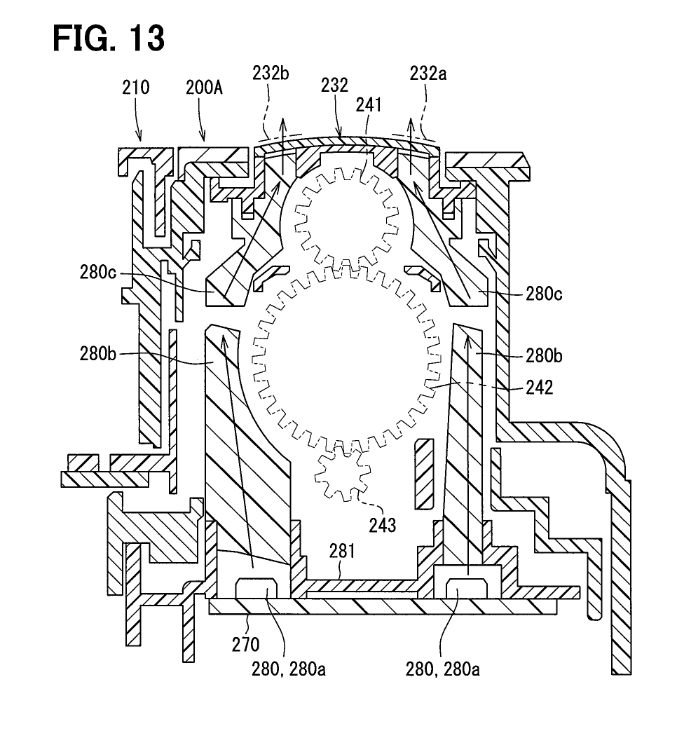

As shown in FIG. 13, the light source portions 280a are provided in the respective illumination units 280 of the circuit board 270. The light source portions 280a are light emitting elements such as LEDs, and are located to correspond to the respective display marks 232a and 232b. A water receiving portion 281 is provided in the circuit board 270 so as to cover the light source portions 280a. The regions of the water receiving portion 281 corresponding to the light source units 280a are opened toward the respective display marks 232a and 232b.

The first light guide portions 280b for guiding the light of the light source units 280a to an intermediate position of the casing 210 is provided in the opening portions. One end side of each first light guide portion 280b is provided so as to be inserted into an opening portion, and the opening portion is closed with the first light guide portion 280b, so that water is restricted from reaching the light source unit 280a side from the water receiving portion 281. Furthermore, second light guide portions 280c are provided for guiding the light of the light source portions 280a from the front end sides of the first light guide portions 280b toward the respective display marks 232a and 232b.

As described above, in the present embodiment, the first to third gears 241 to 243 are configured such that the mutually meshed teeth are shifted in the axial direction and the axial end portions of the teeth are non-contact with each other. As a result, even if minute burrs are present around the axial end portions of the respective gears 241 to 243, meshing between the burrs can be eliminated, so that smooth rotation of the gears 241 to 243 can be achieved.

Further, the main body portion 221 of the scroll wheel 220 is formed as an assembly of multiple components, that is, the first to third wheels 221a to 221c. As a result, those three wheels can be set with different colors, glosses and the like, which makes the scroll wheel 220 rich in design.

In addition, the sliding surface 222d (222e) relative to the support wall 214 is formed to include the recess portions 222f and the protrusion portions 222g, and the parting lines associated with molding are formed in the recess portions 222f. As a result, the contact of the parting lines with the support wall 214 can be eliminated, and the sliding surface 222d (222e) can be smoothly rotated on the support wall 214, so that smooth rotation of the rotational shaft 222 (the first gear 241) can be achieved.

Further, the rotation direction display unit 232 is provided adjacent to the scroll wheel 220 to enable the respective display marks 232a and 232b to be effectively turned on by the light source units 280a and the respective light guide portions 280b and 280c.

### Fifth Embodiment

In the first embodiment described above, the first to third gears 241 to 243 are used as the gears for rotation transmission. On the other hand, the third gear 243 may include multiple gears that mesh with each other, and the shaft portion 250 may rotate with a gear at the final stage of the multiple gears relative to the first gear 241. In other words, four or more gears may be used instead of the three-stage gears of the first to third gears 241 to 243. As a result, the degree of freedom of setting the inter-axis distance between the first gear 241 and the final gear can be increased.

### Other Embodiments

In the first embodiment, the inner peripheral surface of the ring-shaped scroll wheel 120 is formed by the cylinder portion 121, but the cylinder portion 121 may be formed integrally with the scroll wheel 120. In this case, the rotational shaft 130 is connected and fixed to one side of the scroll wheel 120. Further, the scroll wheel 120, the cylinder portion 121, and the rotational shaft 130 may be integrally molded.

Further, a cross-sectional shape of the fixed portion 141 of the fixed shaft 140 is not limited to a quadrangular shape as long as the cross-sectional shape is a non-circular shape, and may be, for example, a polygonal shape other than the quadrangular shape, a cross shape, or the like.

In addition, if the foreign matter entering from the gap 112a is less influential, the flange portion 134 may be eliminated. In that case, with the use of a step between the first shaft portion 131 and the second shaft portion 132 having different shaft diameters, the support wall 113 may be interposed between the axial end portion of the scroll wheel 120 and the step to restrict the position of the rotational shaft 130 in the axial direction.

In the first and second embodiments, the scroll wheel 120 is used for changing the set temperature of the air conditioning wind in the air conditioning apparatus. However, the present disclosure is not limited to the above configuration. The scroll wheel 120 may be used for other applications and other devices such as those for changing the blowing amount of an air conditioning wind or changing the volume of an audio device.

In the third to fifth embodiments, the display device 230 is configured by the self-luminous type display, but the present disclosure is not limited to the above configuration, and a non-luminous type display (for example, a liquid crystal display or the like) requiring another light source unit may be used.

In the third to fifth embodiments, the flange portion 251 is provided on the shaft portion 250. However, the flange portion 251 may be eliminated if the entrance of the foreign matter is less influential.

In the third to fifth embodiments, the photo interrupter 262 is fixed to the circuit board 270. However, depending on a positional relationship between the photo interrupter 262 and the circuit board 270, a dedicated board may be provided, and the photo interrupter 262 may be fixed to the dedicated substrate.

In the third to fifth embodiments, the water receiving portion 281 is provided in the illumination units 280. However, for example, when the water entering from the gap 212a is less influential or when a waterproof structure can be provided in the gap 212a itself, the water receiving portion 281 may be eliminated.

Further, in the third to fifth embodiments, the shaft portion 242a is restricted from slipping off by the elastic portion 242b and the locking claw 242c. Alternatively, another shaft retaining structure (for example, a stopper provided on the shaft portion 242a or the like) may be provided. In short, the shaft portion 242a may be axially supported at a substantial portion without elastic deformation or the like.

In the third to fifth embodiments, the click mechanism of the scroll wheel 220 is formed by the click pin 224 and the spring 225 located in the hole portion 223a of the fixed shaft 223. However, the click mechanism may be provided in other portions (for example, the outer peripheral portion of the scroll wheel 220), or the like.

In the third to fifth embodiments, the scroll wheel 220 is used for changing the set temperature of the air conditioning wind in the air conditioning apparatus. However, the present disclosure is not limited to the above configuration. The scroll wheel 120 may be used for other applications and other devices such as those for changing the blowing amount of an air conditioning wind or changing the volume of an audio device.

The operating device according to the first disclosure described above includes the scroll wheel 120 that is rotationally operated by an operator for input to a predetermined equipment. The scroll wheel has the ring shape, partially protrudes from the opening portion 112 provided in the operation surface 111 of the casing 110 on the operator side, and has the axial direction in a direction along the operation surface within the casing. The operating device further includes the rotational shaft 130 that is located on one axial side of the scroll wheel and rotates together with the scroll wheel. The operating device further includes the fixed shaft 140 that is inserted into an inside of the ring shape on the other axial side of the scroll wheel, and rotationally supports the scroll wheel while being non-rotational. The operating device further includes the corrugated portion 121a whose corrugated shape is continuous in the circumferential direction on the inner peripheral surface of the scroll wheel. The operating device further includes the hole portion 144 that is recessed beyond a center position of the fixed shaft from a predetermined outer peripheral surface position corresponding to the corrugated portion in the axial direction of the fixed shaft. The operating device further includes the elastic member 160 inserted in the hole portion. The operating device further includes the click pin 150 that slides along the inner peripheral surface of the hole portion and has the tip portion urged onto the corrugated portion with the elastic member.

According to the present disclosure, the corrugated portion, the click pin, and the elastic member (click mechanism) can be placed inside the scroll wheel, and no space is required for providing the click mechanism on the outside of the scroll wheel.

The hole portion is formed deeply beyond the center position of the fixed shaft. Therefore, the degree of freedom of setting the dimensions of the elastic member and the click pin in the hole depth direction can be increased. Therefore, the click pin can be elongated along the depth direction of the hole portion to increase a sliding area along the inner peripheral surface of the hole portion. This can make the click pin less subject to falling off from the hole portion before assembly. The fixed shaft on which the click pin is set can be easily assembled to the scroll wheel. Further, the degree of freedom of setting the dimension of the elastic member can be increased. Therefore, the urging force on the click pin by the elastic member is easily set.

Generally, the operating device provided with the click mechanism in the scroll wheel is excellent in assembling property of the click mechanism and can give a favorable click feeling.

The operating device according to the second disclosure described above includes the scroll wheel 220 that partially protrudes from the opening portion 212 provided in the operation surface 211 of the casing 210 on the operator side, is axially supported in the direction along the operation surface in the casing, and is rotationally operated by the operator for input. The operating device further includes the rotational plate 261 that rotates with the rotation operation of the scroll wheel. The operating device further includes the detection unit 262 that is provided on the outer peripheral side of the rotational plate and detects the rotational state of the rotational plate to detect the rotational state of the scroll wheel. The operating device further includes the display device 230 that is located adjacent to one side of the operation surface in the axial direction of the scroll wheel, and displays the input state corresponding to the rotation operation of the scroll wheel 220. The operating device further includes the first gear 241 that is fixed on the side opposite to the display device in the axial direction of the scroll wheel, and rotates together with the scroll wheel. The operating device further includes the second gear 242 that is located on the side away from the operation surface of the first gear, meshes with the first gear, and rotates at a reduced speed relative to the first gear. The operating device further includes the third gear 243 that is located on the side away from the operation surface of the second gear, meshes with the second gear, and rotates at an increased speed relative to the first gear. The operating device further includes the gear shaft 250 rotating together with the third gear. The rotational plate is fixed to the gear shaft and is located on the display device side of the scroll wheel in the axial direction.

According to the above disclosure, the display device is located adjacent to one axial side of the scroll wheel on the operation surface. In addition, the first to third gears are located on a side of the scroll wheel opposite to the display device in the axial direction in a direction away from the operation surface in order. The rotational plate is fixed to the gear shaft of the third gear, and is rotated through the first to third gears and the gear shaft.

In this example, the second gear is a reduction gear relative to the first gear. Therefore, an outer diameter of the second gear is set to be larger than an outer shape of the first gear, so that an inter-axis distance between the first gear and the third gear can be set to be larger. The third gear is a speed increasing gear relative to the first gear. Therefore, a rotating speed of the rotational plate does not become smaller than a rotating speed of the scroll wheel. In other words, the amount of rotation (the amount of movement) of the rotational plate at the outer circumferential portion can be appropriately ensured with respect to the amount of rotation of the scroll wheel, which restricts an issue in detecting the rotational state of the rotational plate by the detection unit.

The inter-axis distance between the first gear and the third gear can be set to be larger. Therefore, the rotational plate does not interfere with the display device, even if the rotational plate is located on the axial display device-side of the scroll wheel. In other words, the display device can be easily set adjacent to the scroll wheel.

Although the present disclosure is described based on the embodiments, it should be understood that this disclosure is not limited to the embodiments or the structure. The present disclosure includes various modification examples and modifications within the equivalent range. In addition, it should be understood that various combinations or aspects, or other combinations or aspects which only one element, one or more elements, or one or less elements are added to the various combinations or aspects, fall within the scope or the technical idea of the present disclosure.

What is claimed is:

1. An operating device comprising:
a scroll wheel rotationally operational by an operator for input on a predetermined device, the scroll wheel in a ring shape, partially protruding on an operator side from an opening portion in an operation surface of a casing, and having an axial direction in a direction along the operation surface within the casing;
a rotational shaft located on one axial side of the scroll wheel and rotational together with the scroll wheel;
a fixed shaft inserted in the ring shape on an other axial side of the scroll wheel and rotationally supports the scroll wheel while being non-rotational;
a corrugated portion formed on an inner peripheral surface of the scroll wheel and in a corrugated shape continuous in a circumferential direction;
a hole portion recessed at a predetermined outer peripheral surface position, which corresponds to the corrugated portion in the axial direction of the fixed shaft, beyond a center position of the fixed shaft;
an elastic member inserted in the hole portion; and
a click pin slidable along an inner peripheral surface of the hole portion and has a tip portion urged onto the corrugated portion with the elastic member.

2. The operating device according to claim 1, wherein
a first sliding surface and a second sliding surface are formed on the inner peripheral surface of the scroll wheel,
the first sliding surface is located on a rotational shaft side of the corrugated portion and is slidable on an outer peripheral surface of the fixed shaft,
the second sliding surface is located on a side opposite of the corrugated portion from the first sliding surface and is slidable on the outer peripheral surface of the fixed shaft,
the second sliding surface reaches an inner circumferential opening of the scroll wheel, and
when an inner diameter of the corrugated portion is defined as a corrugated portion inner diameter, an inner diameter of the first sliding surface is defined as a first inner diameter, and an inner diameter of the second sliding surface is defined as a second inner diameter, the following relationship is satisfied:
(first inner diameter)<(corrugated portion inner diameter)<(second inner diameter).

3. The operating device according to claim 1,
wherein an output gear, which is to output a rotational force of the scroll wheel, is located on the rotational shaft, and
a blocking portion is located on the rotational shaft between the scroll wheel and the output gear to restrict foreign matter, which enters from the opening portion and a gap of the scroll wheel, from moving toward the output gear.

4. The operating device according to claim 3, wherein
the casing has a support wall rotationally supporting the rotational shaft,
the support wall is interposed between an axial end portion of the scroll wheel and the blocking portion, and
the axial end portion of the scroll wheel and the blocking portion regulate an axial position of the rotational shaft relative to the support wall.

5. The operating device according to claim 1, wherein
the scroll wheel is formed as an assembly of a plurality of components aligned in the axial direction.

6. The operating device according to claim 5, wherein
a radial dimension of the fixed shaft on the other axial side of the scroll wheel is set to be smaller than an inner diameter of the scroll wheel in the ring shape, and
an extension portion is located on one of the plurality of components, which is located on the other axial side of the scroll wheel, extends toward an axial center, and covers an radially inner line of the ring shape.

7. An operating device comprising:
a scroll wheel partially protruding on an operator side from an opening portion in an operation surface of a casing, the scroll wheel axially supported in the casing in a direction along the operation surface and rotationally operational by an operator for input;
a rotational plate rotational on a rotational operation of the scroll wheel;
a detection unit located on a radially outside of the rotational plate and to detect a rotational state of the rotational plate so as to detect a rotational state of the scroll wheel;
a display device located on one side of the operation surface, located adjacent to the scroll wheel in an axial direction, and to display an input state corresponding to the rotational operation of the scroll wheel;
a first gear fixed on an opposite side of the scroll wheel from the display device in the axial direction and rotational together with the scroll wheel;
a second gear located on a side of the first gear away from the operation surface, meshes with the first gear, and rotational at a reduced speed relative to the first gear;
a third gear located on a side of the second gear away from the operation surface, meshes with the second gear, and rotational at an increased speed relative to the first gear; and
a gear shaft rotational with the third gear, wherein
the rotational plate is fixed to the gear shaft and is located on a display device side in the axial direction of the scroll wheel.

8. The operating device according to claim 7, wherein the display device is a self-luminous display.

9. The operating device according to claim 7, wherein
a blocking portion is provided on the gear shaft to restrict foreign matter, which enters from a gap between the opening portion and the scroll wheel, from moving toward the detection unit.

10. The operating device according to claim 7, further comprising:
a circuit board located on a side of the rotational plate and the detection unit away from the operation surface and to control a display state of the display device according to a detection signal of the detection unit, wherein
the detection unit is located on an operation surface side of the circuit board.

11. The operating device according to claim 10, further comprising:
an illumination unit located on the operation surface side of the circuit board and to illuminate a space between the opening portion and the scroll wheel, wherein
the illumination unit includes a water receiving portion to store water, which enters from a space between the opening portion and the scroll wheel, and to discharge water to a predetermined area.

12. The operating device according to claim 7, further comprising:
a shaft portion rotational together with the second gear;
an elastic portion located on a front end side of the shaft portion and elastically deformable in a radial direction of the shaft portion; and
a locking claw located at a most front end portion of the elastic portion, wherein
the locking claw and the elastic portion are inserted through a locking hole of a locking wall provided in the casing,
the locking claw restricts the shaft portion from slipping off in the axial direction, and
the shaft portion is pivotally supported in a region excluding a region where the elastic portion is formed.

13. The operating device according to claim 7, wherein
teeth of the first gear, the second gear, and the third gear, which mesh with each other, are axially shifted with each other, and
axial end portions of the teeth are in non-contact with each other.

14. The operating device according to claim 7, wherein
an axial end surface of the scroll wheel forms a sliding surface is slidable on a support wall formed in the casing,
the sliding surface forms a recess and a protrusion and includes a recess portion, which is in non-contact with the support wall, and a protrusion portion which is slidable on the support wall, and
a parting line associated with molding of the scroll wheel is located in the recess portion.

15. The operating device according to claim 7, wherein
the third gear includes a plurality of gears that mesh with each other, and
the gear shaft is rotational together with a gear at a final stage of the plurality of gears relative to the first gear.
